(19) United States
(12) Patent Application Publication
(10) Pub. No.: US 2006/0197270 A1
(43) Pub. Date: Sep. 7, 2006

(54) Retaining device for work pieces, having removable electronic control unit

(75) Inventor: Luciano Migliori, Milano (IT)

Correspondence Address: YOUNG & THOMPSON, 745 SOUTH 23RD STREET, 2ND FLOOR, ARLINGTON, VA, 22202, US

(73) Assignee: UNIVER S.P.A., MILANO (IT)

(21) Appl. No.: 11/367,327

(22) Filed: Mar. 6, 2006

(30) Foreign Application Priority Data
Mar. 7, 2005 (IT) MI2005U000074

(51) Int. Cl. B25B 5/12

(52) U.S. Cl. 269/228; 269/239

(57) ABSTRACT

The retaining device for work pieces, includes a box-shaped body for supporting a movable retaining member for work pieces, position sensing elements for detecting operative positions of the retaining member, an electric actuator for the retaining member, arranged in a casing secured to the box-shaped body, and an electronic control unit inside a box shaped housing removably secured to a side of the same retaining device; the retaining device also includes hooking elements between the casing for the electric actuator and the box shaped housing for the electronic control unit, and fastening elements for fastening the box shaped housing for the electronic control unit to the box-shaped body of the device.

### BACKGROUND OF THE INVENTION

The present invention concerns a retaining device for work pieces, provided with an electronic control unit removably secured to the same device; the device in particular can be in the form of a clamping and/or centering device for metal sheets, used along a motor vehicle body assembly line.

For the purposes of this specification, the expression “retaining devices” is alternatively understood to indicate devices for clamping, underbody clamping, positioning and/or centering work pieces.

### STATE OF THE ART

In general, it is known that in the automotive field use is made of retaining devices for retaining work pieces, for example toggle-lever clamping devices, or gripping and/or centering devices, suitable for gripping, and respectively centering metal sheets, in such a way as to enable them to be joined or welded to one another to form the body of a motor vehicle.

Such devices are known for example from U.S. Pat. No. 6,585,246, U.S. Pat. No. 6,695,359 and EP-A-1 310 332, which in general comprise a box-shaped body for supporting a movable retaining member for work pieces, a detecting system for detecting operative positions of the retaining member, and an electric actuator operatively connected to the retaining member.

In such conventional devices, the detecting system is housed in the box-shaped body, and the actuator is arranged in a casing secured to the box-shaped body.

The above devices also comprise an electronic control unit, in order to set up and control the functioning of the same devices; the electronic control unit is operatively connected to the detecting system and to the electric actuator, and in general it is housed inside the same devices, in particular inside the casing for the electric actuator.

However, such a position for the electronic control unit is not optimal, in that, in the event of malfunctioning or failure of the electronic unit, time consuming and complex operations are required by operators in order to gain access to the unit and proceed to its replacement, involving prolonged machine down times and consequently high costs.

In addition, the electronic control unit, inside the casing for the actuator is subjected both to thermal stresses, caused by heating of the electric actuator, and to malfunctioning caused by pollutants that may have infiltrated into the same retaining device, such as dust, lubricants, and the like.

In order to at least partly obviate these drawbacks, in EP-A-1 201 370 an electrically controlled retaining device for work pieces has been proposed, in which the electronic control unit is enclosed in a containing box secured to a side of the casing for the electric actuator.

Such solution allows a reduction in the necessary times for replacement of the electronic control unit, in that it is in a more easily accessible position for the operators.

Moreover, the electronic control unit is located in a separate environment, outside of the retaining device, thereby achieving an improvement in the operative conditions of the control unit itself, thanks to a reduction in the thermal stresses and the absence of harmful environmental agents.

However, in EP-A-1 201 370 no indication or mention is made of suitable means for securing the box for the electronic control unit to the retaining device, which could allow the same unit to be quickly and easily replaced.

In addition, it is not possible to directly pre-set or modify in an easy way the operation of the electronic control unit, in relation to the operative requirements, but it is necessary to reprogram the same unit by means of a remotely connected computer, which is a time consuming and difficult operation.

### OBJECTS OF THE INVENTION

The main object of this invention is to provide a retaining device for work pieces, of the aforementioned kind, which effectively allows a quick and easy replacement of the electronic control unit, thereby achieving a reduction in the times required for the same replacement, and consequently limiting the machine down times.

A further object of this invention is to provide a retaining device of the aforementioned kind, in which it is possible to pre-set and modify the functioning of the same device, by directly operating on the electronic control unit, in a easy way.

### BRIEF DESCRIPTION OF THE INVENTION

The above can be achieved by means of a retaining device for work pieces, of the type comprising:

a box-shaped body having a longitudinal axis;

a retaining member for a work piece, movably supported at a first end of the box-shaped body;

position sensing means for detecting operative positions of the retaining member, said position sensing means being housed in said box-shaped body;

at least one electric actuator operatively connected to the retaining member, said actuator being arranged in a casing secured to a second end of the box-shaped body;

an electronic control unit operatively connected to the position sensing means and to the electric actuator, said electronic control unit being inside a box shaped housing secured to a side of same the retaining device,

disengageable hooking means between said casing for the electric actuator and said box shaped housing for the electronic control unit, and

disengageable fastening means for fastening said box shaped housing for the electronic control unit to said box-shaped body of the device, said hooking means and said fastening means being arranged at a bottom and upper sides of the box shaped housing for the control unit, and conformed to allow a pivotal hooking movement of the box shaped housing in respect to the casing for the actuator.

### BRIEF DESCRIPTION OF THE DRAWINGS

These and further features according to this invention, will be more clearly evident from the following description with reference to the accompanying drawings, in which:

FIG. 1 shows a longitudinal sectional view of a retaining device for work pieces, according to this invention;

FIG. 2 shows an enlarged detail of the fastening means for fastening the box shaped housing for the electronic control unit to the box-shaped body of the device of FIG. 1;

FIG. 3 shows an enlarged detail of the hooking means for connecting the box shaped housing for the electronic control unit to the casing for the electric actuator of the device of FIG. 1; and

FIG. 4 shows a block diagram of an embodiment of the electronic control unit of the device of FIG. 1;

FIG. 5 shows a second embodiment of the retaining device according to this invention.

### DETAILED DESCRIPTION OF THE INVENTION

The general features of this invention will be illustrated hereunder by means of several embodiments.

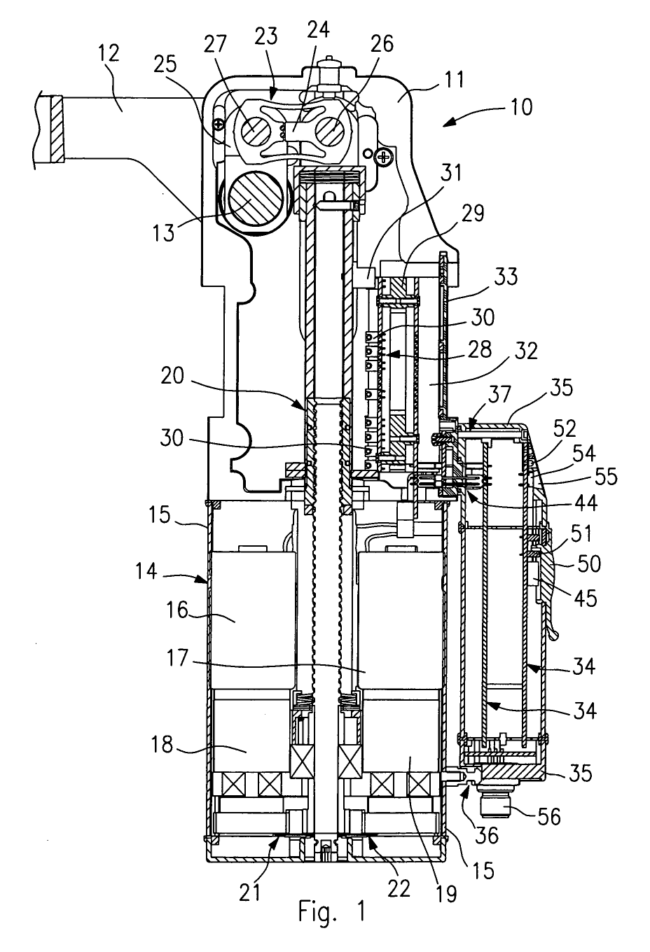

FIG. 1 shows a retaining device for retaining work pieces according to a first embodiment of this invention, in this case in the form of a toggle-lever clamping device, as a whole indicated by the reference number 10.

The device 10 comprises a box-shaped body 11 having a longitudinal axis, and a retaining member 12 for the work pieces, movably supported at first end of the box-shaped body 11; in particular, in this embodiment, the retaining member 12 is in the form of an angularly movable clamping arm 12, supported by the box-shaped body 11 by means of a pivotal axis 13 on a front side of the same box-shaped body 11.

The device 10 also comprises at least one electric actuator 14 operatively connected to the retaining member 12, the actuator 14 being arranged in a casing 15 secured to a second end of the box-shaped body 11.

In the illustrated case, the electric actuator 14 comprises a first and a second electric motor 16, 17, each provided with an epicyclic reduction unit 18, 19, which in turn are operatively connected to an axially extensible screw-nut thrust member 20, by means of respective gear transmission units 21, 22.

It is not excluded however that the electric actuator 14 can comprise only a single electric motor, or that the device 10 can be operated by means of another suitable linear actuator, such as for example a pneumatic cylinder or an electric cylinder, in which the thrust member consists of an axially movable rod of the same cylinders.

In turn, the thrust member 20 is operatively connected to the retaining member 12 by means of a toggle-lever mechanism 23, preferentially comprising a connecting link 24 which has a controlled elastic yielding in an axial direction, and a crank 25 integrally movable in rotation with the retaining member 12, the connecting link 24 being articulated with the thrust member 20 by a pivot 26 and with the crank 25 by a pivot 27.

The device 10 also comprises position sensing means 28 for detecting operative positions of the retaining member 12, housed in the box-shaped body 11; preferentially, the sensing means 28 comprises an elongated support element 29 onto which a plurality of detecting sensors 30 is secured, spaced apart from one another and aligned in a longitudinal direction, in such a way as to be able to detect the position of a lug or protrusion 31 connected to the axially extensible thrust member 20.

The support element 29 for the sensors 30 is preferentially inserted into the box-shaped body 11 through a side opening 32 provided in the same box-shaped body 11, which can be tightly closed by means of an appropriate closing cover 33.

The retaining device 10 comprises an electronic control unit 34 operatively connected to the sensing means 28 and to the electric actuator 14, the control unit 34 being inside a removable box shaped housing 35 secured to a side of the retaining device 10.

In order to allow a quick and easy replacement of the electronic control unit 34, the device 10 is provided with disengageable hooking means 36 between the casing 15 for the electric actuator 14 and the box shaped housing 35, for the electronic control unit 34, as well as disengageable fastening means 37 for fastening the box shaped housing 35 for the electronic control unit 34 to the box-shaped body 11 of the device 10.

The hooking means 36 and the fastening means 37 are respectively arranged at bottom and upper sides of the box shaped housing 35 for the control unit 34; such a configuration allows a pivotal hooking movement of the box shaped housing 35 in respect to the casing 15 for the actuator 14.

Preferentially, as illustrated in FIG. 2, the disengageable fastening means 37 comprise at least one screw type fastening means 38 on the box shaped housing 35, engageable in a corresponding threaded hole 39 provided in the box-shaped body 11 on the fastening side for the same box-shaped housing 35.

Preferentially, as illustrated in FIG. 3, the hooking means 36 conversely comprise a hooking pin 40 provided with an enlarged head 41, the hooking pin 40 being secured to the casing 15 for the electric actuator 14 by a screw 40′ and extending onto a side of the same casing 15 corresponding to the side of the device 10 designed for fastening the box shaped housing 35 for the control unit 34.

Moreover, the hooking means 36 comprise a shaped cavity 42 at the bottom of the box shaped housing 35, having a tooth 43 designed to engage with the head 41 of the hooking pin 40.

As illustrated in FIGS. 1 and 2, the retaining device 10 comprises electrical connecting means 44 for the reciprocal electrical connection between the electronic control unit 34, the sensing means 28 and the electric actuator 14, for example in the form of a connector provided with at least one plug 44′ and one socket 44″, which are disengageable in an orthogonal direction with respect to the axis of the device 10, the connecting means 44 being provided in corresponding positions on the box-shaped body 11 of the device 10 and on the box shaped housing 35 for the electronic control unit 34.

Thanks to the fastening means 37, the hooking means 36 and the electrical connecting means 44 referred to above, it is possible to quickly and easily replace the electronic control unit 34, for example in the event of malfunctioning or failure, or when particular operative conditions are required; in particular, the operations necessary for assembling or connecting the box shaped housing 35 onto the device 10 are essentially the following:

placing the box shaped housing 35 on the side onto which the latter is to be fastened;

engaging the hooking pin 40 into the cavity 42 of the box shaped housing 35;

bringing the electrical connecting means 44 to engage with one another by a pivotal movement of the box shaped housing 35 in respect to the casing 15; and

securing the screw means 38 into the threaded hole 39 in the box-shaped body 11 of the device 10.

The operations for disassembling the box shaped housing 35 are the exact reverse of those listed above.

Preferentially, the electronic control unit 34 is preset for selectively activating at least one of the detecting sensors 30, in relation to at least one pre-established position of the retaining member 12 to be detected.

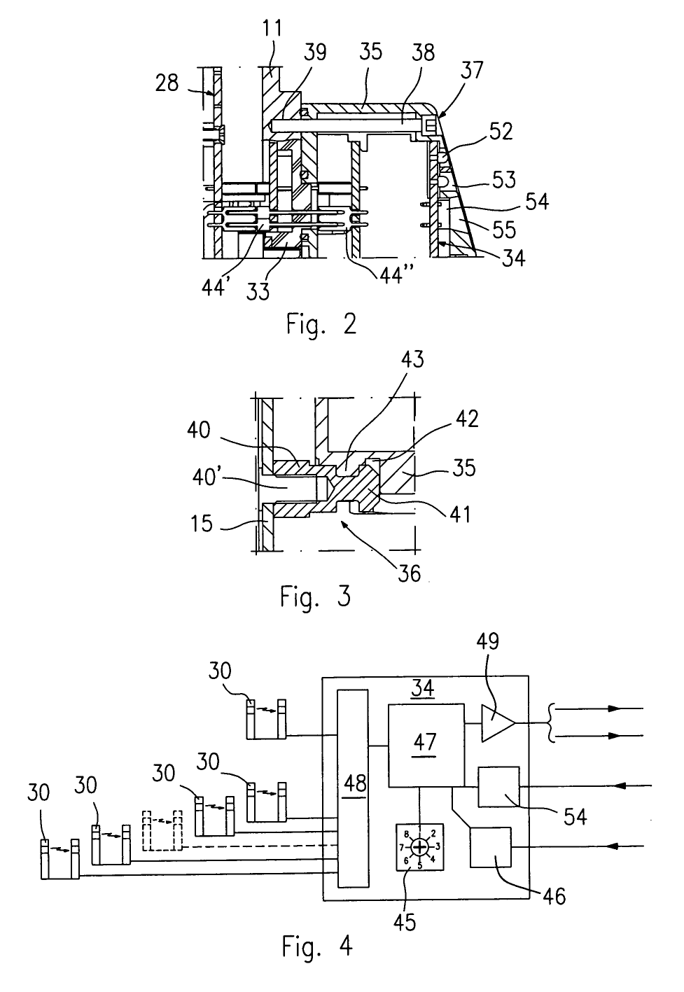

Moreover, the electronic control unit 34 can comprise selection means 45 for selecting the sensor to be activated from among the plurality of detecting sensors 30 provided, for example a rotary type switch, as illustrated in FIG. 4, or a linear switch, or other suitable selection means, for example of self-learning type.

The operation of the retaining device 10 is enabled by the electronic control unit 34, in relation to appropriate control signals which can be supplied by a manual push button 54, connected to the same control unit 34 and accessible through an opening in the box shaped housing 35, and/or supplied by an external central control system, not shown, connected to the electronic control unit 34 by means of a connector 56.

FIG. 4 shows the block diagram of the electronic control unit 34, in which it can be seen that the unit 34 is powered by a power supply 46 and comprises a rotary switch 45, having a number of switching positions (1-8) corresponding to the number of sensors 30 which can be activated; the unit 34 also comprises a data and information processing unit 47 which, depending upon the signals received from the switch 45, and from the detecting sensors 30 through the interface 48, and upon the control signals referred to above, supplies working signals through a buffer 49, so as to control or ascertain the position of the retaining member 12.

Thanks to the selection means 45, it is possible to preset and modify the functioning of the device 10 by directly operating in an easy way on the electronic control unit 34, thereby achieving considerable versatility in its use, and limiting the time required for presetting the different operative modes.

The box shaped housing 35 for the electronic control unit 34 is provided with an access opening for the selection means 45 which can be tightly closed by means of a removable closing cap 50.

Preferentially, the electronic control unit 34 comprises activation means 51 for activating the retaining device 10 which can be operatively actuated by means of the closing cap 50, for example in the form of a sensor 51 which detects the presence of the closing cap 50.

Moreover, the electronic control unit 34 can comprise electronic indicating means 52 for visual indication of the operative position of the retaining member 12, for example LEDs or other suitable means, which are disposed in correspondence with at least one hole or aperture 53 in the box shaped housing 35.

Preferentially, in the case of the toggle-lever clamping device of FIG. 1, which has a rectangular cross section according to a plane orthogonal to the longitudinal axis, the box shaped housing 35 for the electronic control unit 34 is secured a rear short side of the same device 10.

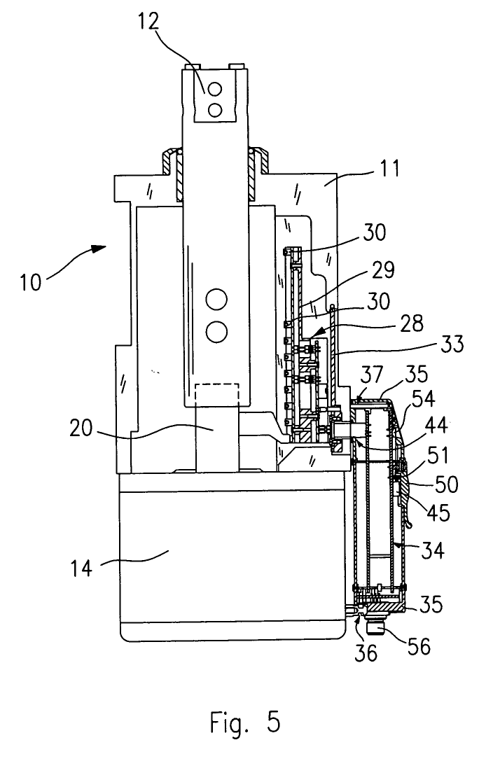

FIG. 5 shows a second embodiment of the retaining device 10 according to this invention, in the form of a centering device, in which the same reference numbers have been used to indicate similar or equivalent parts.

In this embodiment, the retaining member 12 is a longitudinally movable centering pin, slidingly supported by the box-shaped body 11 of the device 10, which is directly connected to the axially extensible thrust member 20, the thrust member 20 in turn being connected to the electric actuator 14.

In a wholly similar way with respect to the embodiment described above, an electronic control unit 34 is provided, which is arranged in a removable box shaped housing 35 secured to a side of the device 10, and, likewise, position sensing means 28 for detecting the position of the retaining member 12 are provided; reference is also made to the description given above for the characteristics and features of the control unit 34, its fastening and the sensing means 28.

The retaining device may also be in the form of an underbody clamping device, illustrated for example in the patent application EP-A-1 386 697 of the same applicant; reference is made to the description of the latter for defining the general characteristics of the aforesaid device.

In this embodiment, the retaining member is in the form of a hook shaped member, which is supported by the box-shaped body to perform an operative translation movement between a forward position in which it releases and a backward position in which it retains a work piece.

Likewise to the previously described embodiments, an underbody clamping device according to this invention is provided with an electronic control unit inside a removable box shaped housing, secured to a side of the device by the described means, and comprises position sensing means for detecting the position of the retaining member.

What has been described and shown with reference to the accompanying drawings, has been given purely by way of example in order to illustrate the general features of the invention, and several of its preferential embodiments; therefore, other modifications and variations to the clamping and/or centering device are possible, without thereby deviating from the scope of the claims.

What we claim is:

1. Retaining device for work pieces, of the type comprising:
a box-shaped body having a longitudinal axis;
a retaining member for a work piece, movably supported at a first end of the box-shaped body;
position sensing means for detecting operative positions of the retaining member, said position sensing means being housed in said box-shaped body;
at least one electric actuator operatively connected to the retaining member, said actuator being arranged in a casing secured to a second end of the box-shaped body;
an electronic control unit operatively connected to the position sensing means and to the electric actuator, said electronic control unit being inside a box shaped housing secured to a side of the same retaining device;
disengageable hooking means between said casing for the electric actuator and said box shaped housing for the electronic control unit, and
disengageable fastening means for fastening said box shaped housing for the electronic control unit to said box-shaped body of the device, said hooking means and said fastening means being arranged at a bottom and upper sides of the box shaped housing for the control unit, and conformed to allow a pivotal hooking movement of the box shaped housing in respect to the casing for the actuator.

2. Retaining device for work pieces according to claim 1, wherein said disengageable fastening means comprise at least one screw-type fastening means on the box shaped housing for the electronic control unit, which engages in a corresponding threaded hole provided in the box-shaped body of the device on a side designed for fastening the same box shaped housing.

3. Retaining device for work pieces according to claim 1, wherein said hooking means comprise:
a hooking pin provided with an enlarged head, said hooking pin extending on a side of the casing for the electric actuator corresponding to the side of the device designed for fastening the box shaped housing for the control unit, and
a shaped cavity in said box shaped housing, having a tooth for engaging with the head of the hooking pin.

4. Retaining device for work pieces according to claim 1, comprising electrical connecting means for reciprocal electrical connection between the electronic control unit, the position sensing means and the electric actuator, said electrical connecting means being provided in corresponding positions on the box-shaped body of the device and on the box shaped housing for the electronic control unit.

5. Retaining device for work pieces according to claim 1, wherein said sensing means for detecting the position of the retaining member comprises a plurality of detecting sensors spaced apart from one another and aligned in a longitudinal direction on an elongated support element, the electronic control unit being pre-set to selectively activate at least one of the sensors of said plurality of sensors, in relation to at least one pre-established position of the retaining member to be detected.

6. Retaining device for work pieces according to claim 5, wherein the electronic control unit comprises selection means for selecting the sensor to be activated from among said plurality of detecting sensors.

7. Retaining device for work pieces according to claim 6, wherein the box shaped housing for the electronic control unit is provided with an access opening for said selection means for selecting the detecting sensors, a removable cap being provided for tightly closing said access opening.

8. Retaining device for work pieces according to claim 7, wherein the electronic control unit comprises activation means for activating the retaining device which can be operatively actuated by said closing cap.

9. Retaining device for work pieces according to claim 1, wherein said electronic control unit comprises electronic indicating means for visual indication of the operative position of the retaining member, said visual indicating means being disposed in correspondence with at least one aperture in said box shaped housing for the control unit.

10. Retaining device for work pieces according to claim 1, wherein said electronic control unit is pre-set for receiving and processing control signals for enabling the operation of the same device.

11. Retaining device for work pieces according to claim 1, the form of a toggle-lever clamping device, in which the retaining member is an angularly movable clamping arm, pivotally supported by the box-shaped body of the device on a front side of the box-shaped body.

12. Retaining device for work pieces according to claim 11, in which the device has a rectangular cross section according to a plane orthogonal to the longitudinal axis, wherein the box shaped housing for the electronic control unit is secured on a rear short side of the same device.

13. Retaining device for work pieces according to claim 1, in the form of a centering device, in which the retaining member is a longitudinally movable centering pin, slidingly supported by the box-shaped body of the device.

14. Retaining device for retaining work pieces as claimed in claim 1, in the form of an underbody clamping device, in which the retaining member is in the form of a hook shaped member supported by said box-shaped body to perform an operative translation movement between a forward position in which it releases and a backward position in which it retains a work piece.
